(19) United States
(12) Patent Application Publication
(10) Pub. No.: US 2009/0277720 A1
(43) Pub. Date: Nov. 12, 2009

(54) Ladder standoff attachment

(76) Inventor: J. Gary Henderson, Coeur D'Alene, ID (US)

Correspondence Address: Gregory IPL, P.C., 601 W. Main Avenue, Suite 904, SPOKANE, WA, 99201-3825, US

(21) Appl. No.: 12/151,968

(22) Filed: May 8, 2008

(51) Int. Cl. E06C 7/48; B23P 11/00

(52) U.S. Cl. 182/107; 29/428; 182/214

(57) ABSTRACT

An apparatus forming a ladder standoff attachment for use with a ladder to stabilize the ladder against a structure and provide protection against electrical shock includes at least two arms and at least one cross piece connected between respective lower portions of the arms to join the arms. The cross piece is adapted for connection to, and detachment from, the ladder. The apparatus also includes a multilayer dielectric sheath covering at least a portion of each of the arms to substantially prevent electrical charge from flowing to or from the at least two arms from a source of electrical charge.

### TECHNICAL FIELD

The technical field of the inventions are ladders and accessories for use with ladders. More specifically, the technical field of the inventions is a ladder standoff assembly for attachment to, and use with, a ladder.

### BACKGROUND OF THE INVENTION

Ladders, and more specifically extension ladders, are commonly employed by homeowners, contractors, maintenance workers and others for gaining access to rooves and other elevated portions of houses, buildings and other structures for maintenance, repair and construction. One type of ladder accessory that is gaining acceptance is known as a ladder stabilizer or standoff. Generally, such a stabilizer or standoff is designed to be attached to an upper end of a ladder such as an extension ladder. Conventional ladder stabilizers usually include a pair of spaced-apart feet that are intended to rest against a wall or roof of a building or other structure. The feet are often covered with pliable pads. Such stabilizer assemblies usually also include means of securely attaching the assembly to an upper portion of a ladder.

There is generally one or more intended purposes of the ladder stabilizer. These purposes may include: spacing the ladder top away from the structure upon which it is leaning to facilitate easier access to a vertical wall or roof of the structure; and, providing a wider stance or base of contact between the ladder and the structure upon which the ladder is leaning to facilitate greater stability of the ladder.

A great many conventional ladders are fabricated mostly, if not totally, from aluminum material. It is widely known that aluminum is highly conductive of electricity. Moreover, electrical power sources of dangerous levels are usually located in and around areas of buildings in which ladders are commonly used. For example, electrical power drop lines are located at or near roof-level on many residential buildings and even on some commercial buildings. Also, in commercial and industrial settings, rooftop areas of buildings often support transformers, power supplies and other such devices having potentially dangerous levels of electrical power. Accordingly, there exists a continuing need for an improved ladder stabilizer assembly that minimizes the possibility of electrocution of the ladder user.

Some or all of the problems explained above and other problems may be helped or solved by the inventions shown and described herein. Such inventions may also be used to address other problems not set out above or which are only understood or appreciated at a later time. The future may also bring to light currently unknown or unrecognized benefits which may be appreciated or more fully appreciated in the future associated with the novel inventions shown and described herein.

### BRIEF DESCRIPTION OF THE DRAWINGS

Preferred forms, configurations, embodiments and/or diagrams relating to and helping to describe preferred aspects and versions of the inventions are explained and characterized herein, often with reference to the accompanying drawings. The drawings and all features shown therein also serve as part of the disclosure of the inventions of the current document, whether described in text or merely by graphical disclosure alone. Such drawings are briefly described below.

FIG. 1 is a top view of a ladder stabilizer attachment in accordance with the preferred inventions.

FIG. 2 is a front view of the ladder stabilizer attachment shown in FIG. 1.

FIG. 3 is a side view of the ladder stabilizer attachment shown in FIG. 1.

FIG. 4 is a rear view of the ladder stabilizer attachment shown in FIG. 1.

FIG. 5 is a front view of the ladder stabilizer attachment shown in FIG. 1, attached to a ladder, which is shown in phantom.

FIG. 6 is a partial sectional view taken along line 6-6 of FIG. 5.

FIG. 7 is a sectional view taken along either line 7-7 of FIG. 1.

FIG. 8 is a cutaway view of the dielectric sheath 144 in isolation.

### DETAILED DESCRIPTION OF THE PREFERRED EMBODIMENTS

A table of subsections for the detailed description is set out below.

### Table of Subsections

Introductory Notes

General Overview of Apparatus

Arms

End Caps

Cross Pieces

Dielectric Sheath

Methods

Manner of Use and Utility of the Inventions

Preferred Manners of Making

Interpretation Notes

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (© 1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the inventions. Wording used in the claims is also descriptive of the inventions, and the text of both claims and abstract are incorporated by reference into the description entirely in the form as originally filed. Terminology used with one, some or all embodiments may be used for describing and defining the technology and exclusive rights associated herewith.

The readers of this document should further understand that the embodiments described herein may rely on terminology and features used in any section or embodiment shown in this document and other terms readily apparent from the drawings and language common or proper therefor. This document is premised upon using one or more terms or features shown in one embodiment that may also apply to or be combined with other embodiments for similar structures, functions, features and aspects of the inventions and provide additional embodiments of the inventions.

### General Overview of Apparatus

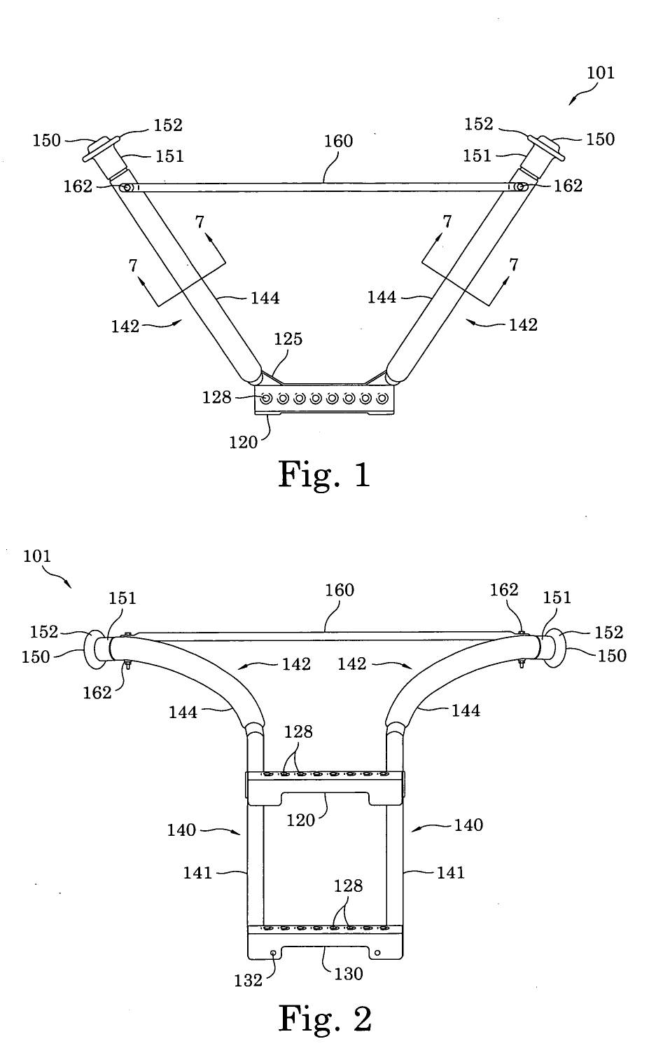

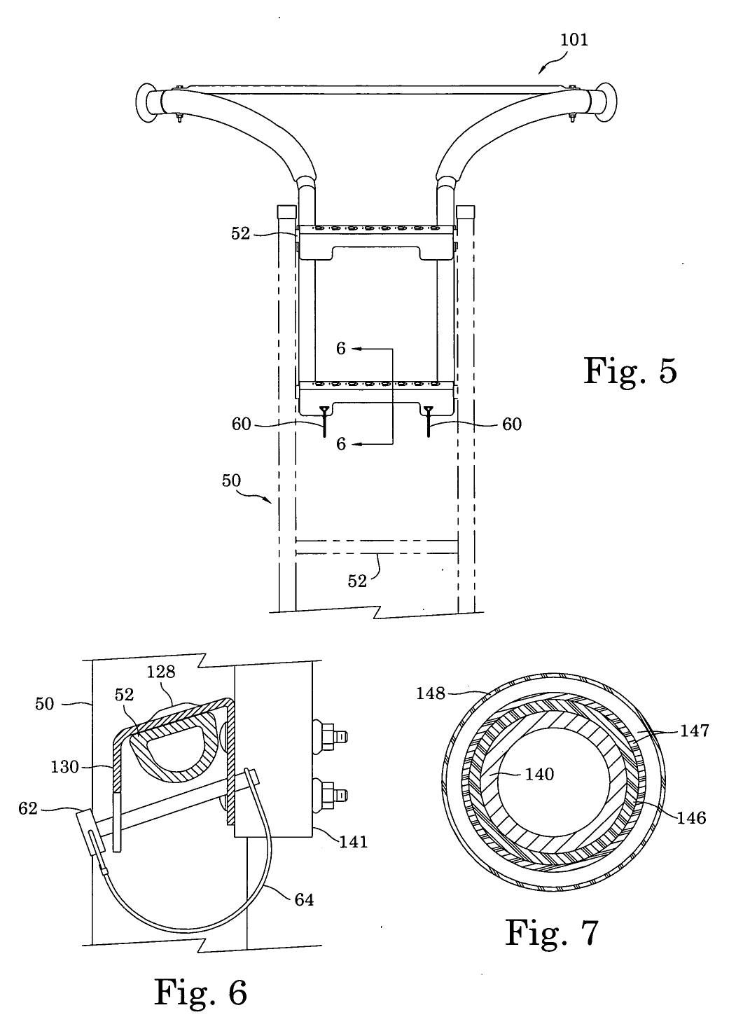

To facilitate an understanding of the inventions, a general overview of an apparatus 101 in accordance with a preferred embodiment of the inventions is first provided. With reference to FIGS. 1-4, the apparatus 101 is depicted in a top, a front, a side, and a rear view, respectively. The apparatus 101 can be generally described as a ladder accessory or apparatus for use with a ladder while the ladder leans against a structure such as a building. More specifically, the apparatus 101 can be generally described as a ladder standoff or stabilizer attachment for use with a ladder. The apparatus 101 is adapted to be attached to the top, or upper portion, of a conventional ladder 50, as shown in FIG. 5. An apparatus in accordance with one or more embodiments of the inventions may or may not include the ladder 50. The apparatus 101 includes one or more dielectric aspects to decrease risk of electrocution as is explained in greater detail herein below.

### Arms

With reference to FIGS. 1-5 and 7, the apparatus 101 includes two or more arms 140. Each of the arms 140 has a lower portion 141 and an upper portion 142. The upper portion 142 is adapted to extend toward a structure (not shown) on or against which the ladder 50 may lean. The lower portion 141 is adapted to be connectible to the ladder. Each of the arms 140 is preferably in the form of a structural member such as a structural tube. In accordance with the preferred embodiment of the inventions, the arms 140 are fabricated from aluminum alloy structural tube having a substantially circular cross section.

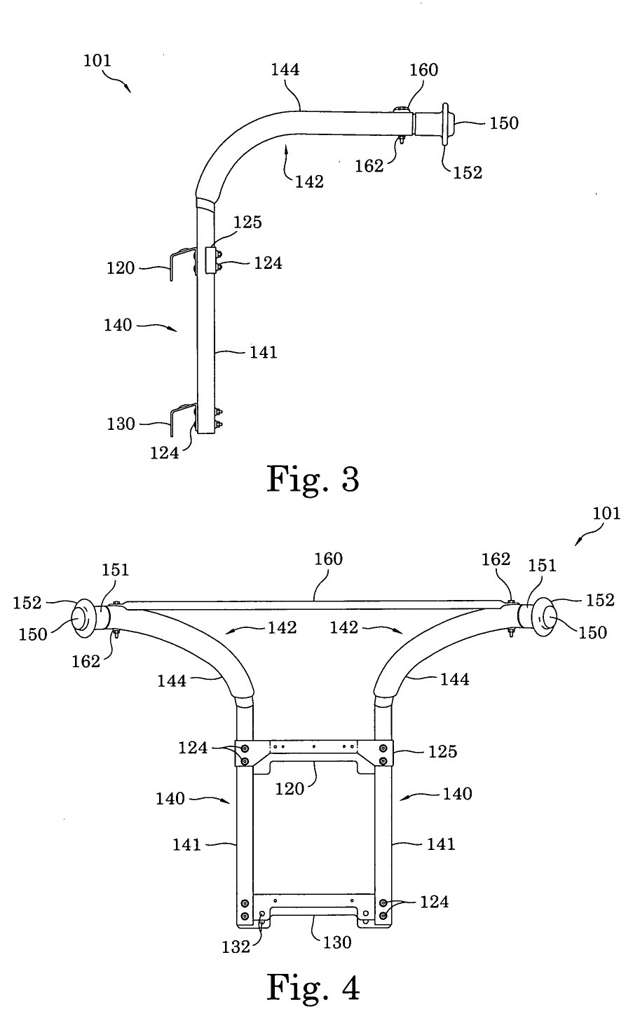

Still referring to FIGS. 1-5, each of the arms 140 is preferably shaped as shown to provide the respective upper portion 142 and lower portion 141. The upper and lower portions of each respective arm 140 are preferably joined together. More preferably, the upper and lower portions of each respective arm 140 are integrated into a substantially unitary member. In the preferred embodiment of the apparatus 101, the lower portions of the arms are in substantially parallel orientation relative to one another as can be seen in FIGS. 2 and 4, while the upper portions of the arms are in obliquely divergent orientation or relationship as can be seen in FIGS. 1, 2 and 4. As can be seen from a study of FIG. 3, at least part of each lower portion 141 are substantially normal to at least part of the respective upper portion 142, in accordance with the preferred embodiment of the inventions. In addition to those specifically discussed and/or shown herein, other suitable forms, configurations and/or orientations of the arms 140 may be employed in accordance with one or more embodiments of the inventions.

### End Caps

Referring now to FIGS. 1-4, each of the arms 140 has a respective distal end 150. More specifically, a respective distal end 150 is defined on each upper portion 142 of each arm. In accordance with the preferred embodiment of the inventions, the upper portion 142 of each arm 140 is between the respective lower portion 141 and the respective distal end 150. The distal ends 150 are adapted to engage or bear against a structure (not shown) such as a building when the ladder stabilizer assembly 101 is ready for use by being properly positioned relative to the structure.

With continued reference to FIGS. 1-4, the apparatus 101 includes one or more end caps 151, in accordance with the preferred embodiment of the inventions. Each cap 151 may be positioned on a respective distal end 150 of an arm 140 as shown. The end cap 151 is preferably fabricated from a material that substantially pliable so as to decrease likelihood of damage to the structure (not shown) with which the apparatus is engaged when in use. More preferably, the end cap 151 is fabricated from a material that is substantially dielectric so as to prevent or impede electrical current passing through the cap and reaching the arm 140. In accordance with the preferred embodiment of the inventions, the end cap 151 includes an outwardly extending annular flange 152, which may bear against a roof in a common mode of use

### Cross Pieces

Still referring to FIGS. 1-4, the apparatus 101 includes at least one cross piece 120, 130 connected between the lower portions 141 of the arms 140. In accordance with the preferred embodiment of the inventions, the apparatus 101 includes an upper cross piece 120 and a lower cross piece 130. A brace 125 may be used to secure at least one cross piece such as the upper cross piece 120 between the lower portions 141 of the arms as depicted. Each of the cross pieces 120, 130, as well as the brace 125 is preferably secured to the arms 140 by respective fasteners 124 as shown. However, other suitable means of connecting the cross pieces 120, 130 to the arms 140 may be employed in accordance with one or more embodiments of the inventions.

Each of the cross pieces 140 may be substantially in the form of a rung or step. More preferably, each of the cross pieces 120, 130 is substantially in the form of an inverted channel fabricated from a suitable material, such as galvanized steel or an aluminum alloy sheet. Each of the cross pieces 140 may define one or more gripping features 128 to facilitate traction of footwear when a user steps on the cross piece. At least one of the cross pieces, such as the lower cross piece 130, may have one or more retainer features 132 as shown.

The cross pieces 120, 130 may be adapted for detachable connection to the ladder 50. In accordance with the preferred embodiment of the inventions, each of the cross pieces 120, 130 is adapted to fit in substantially nested fashion over a respective rung 52 of the ladder 50, as shown in FIGS. 5 and 6. More preferably, one or more of the cross pieces 120, 130 is in the form of a rung which is adapted to be received into complimentary relationship with a ladder 50 to which the apparatus 101 may be mounted for use as shown in FIG. 5. In accordance with the exemplary embodiment, one or more of the cross pieces 120, 130 is adapted for connection of the standoff assembly 101 to a ladder 50 and detachment from the ladder.

As is also shown in FIG. 5, the apparatus 101 may include at least one retainer 60 adapted to engage the respective retainer feature 132 (shown in FIGS. 2 and 4). Such engagement of the retainer 60 with the engagement feature 132 can serve to secure the apparatus 101 to the ladder 50. With reference to FIGS. 5 and 6, the retainer 60 is preferably in the form of a pin 62 with an attached bail or clip 64, wherein the retainer feature 132 (shown in FIGS. 2 and 4) is substantially in the form of an aperture adapted to receive the pin. The bail or clip 64 is adapted to prevent the pin 62 from slipping out of position after being installed as shown in FIGS. 5 and 6.

### Dielectric Sheath

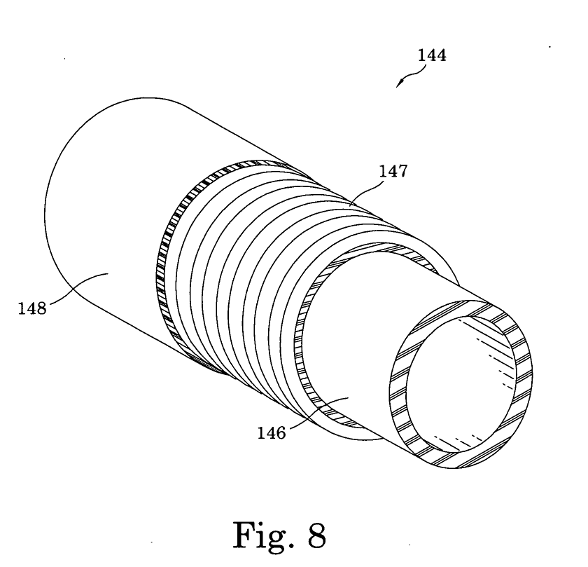

The apparatus 101 includes a multilayer dielectric sheath 144. A cutaway view of the dielectric sheath 144 in isolation is shown in FIG. 8. Preferably, the dielectric sheath 144 includes two or more dielectric layers 146, 147, 148, wherein each layer is of a material and/or configuration that is different from the other layers. Most preferably, the dielectric sheath 144 includes three dielectric layers as shown, wherein each of the three layers is of a material and/or configuration that is different from any of the other layers.

Referring now to FIG. 7, a sectional view is shown to be taken along either section line 7-7 of FIG. 1. The dielectric sheath 144 preferably includes an inner layer 146, an intermediate layer 147, and an outer layer 148. The inner layer 146 surrounds at least a portion of the respective arm 140. The intermedia layer 147 surrounds at least a portion of the respective inner layer 146. The outer layer 148 surrounds at least a portion of the intermediate layer 147.

With reference to FIGS. 1-5, 7 and 8, in accordance with the preferred embodiment of the inventions, the inner layer 146 is a length of substantially rigid tubing, while the intermediate layer 147 is a length of corrugated plastic flexible tubing, and the outer layer 148 is a length of heat shrink tubing. The heat shrink tubing is preferably sized and/or shrunk to a size so as to compress and fit about the assembly by the one or more the inner layers as well as the arm 140. The outer layer 148 is also preferably longer than both the inner layer 146 and the intermediate layer 147 so as to substantially seal the ends of the dielectric sheath layers against the respective arm.

As can be seen from a study of FIGS. 1-4, the dielectric sheath 144 is preferably positioned to substantially surround at least the respective upper portion 142 of each respective arm 140. More preferably, the dielectric sheath 144 is positioned to surround the respective upper portion 142 as well as at least part of the lower portion 141 of each respective arm 140. In accordance with the exemplary embodiment, each end cap 151 overlaps at least one of the layers of the respective dielectric sheath 144. More specifically, each dielectric sheath 144 is preferably positioned substantially adjacent to the respective end cap 151, while the end cap also preferably overlaps at least a portion of the outer layer 148 of the dielectric sheath.

In accordance with the preferred embodiment of the inventions, each of the layers of the dielectric sheath 144 is fabricated from a material that is at least substantially dielectric. For example, one or more layers of the dielectric sheath, as well as other dielectric components of the apparatus 101, may be fabricated from one or more materials such as, but not limited to, rubber, nylon, polypropylene, polyethylene, polyvinylchloride, polyurethane, polyester, and other suitable materials now known or hereafter developed.

### Upper Strut

Referring now to FIGS. 1-4, the apparatus 101 may include an upper strut 160 connected between the upper portions 142 of the arms 140. In accordance with the preferred embodiment of the inventions, the upper strut 160 is adapted to substantially stabilize the upper portions 142 of the arms 140 relative to each other. Preferably, the upper strut 160 is connected to each of the arms 140 proximate the respective distal ends thereof as shown. Additionally, the upper strut, when connected to the arms, is preferably in substantial contact with the dielectric sheath 144.

Still referring to FIGS. 1-4, an exemplary embodiment of the inventions includes the upper strut 160 which is connected to each arm 140 by a respective strut fastener 162. The strut fasteners 162 pass through the respective dielectric sheath 144 as well as the respective arm 140 in accordance with one or more preferred embodiments of the invention. The strut fasteners 162 are preferably made from a dielectric material to prevent conduction of electrical current to or from the arm 140 through which the strut fastener passes in accordance with the exemplary embodiment of the inventions. Other suitable means of connecting the upper strut 160 to the arms 140 may be employed in accordance with one or more embodiments of the inventions. Such other suitable means may include, for example, bands or clamps, preferably made from dielectric materials.

### Methods

With reference now to FIGS. 1-8, one preferred embodiment of the inventions includes a method of fabricating a ladder standoff attachment 101 for use with a ladder 50 to stabilize the ladder when placed against a structure (not shown) such as a building, building roof or other locations, so as to provide protection against electrical shock. The method includes forming at least two arms 140. Forming the arms preferably includes shaping the arms to provide lower portions 141 and upper portions 142. The method includes forming the upper and lower portions so as to be joined together. The arms 140 may be formed from round aluminum alloy tubing. Furthermore, the arms 140 may be formed by bending.

The method may further include forming the lower portions 141 so as to be connectible to a ladder 50 and forming the upper portions 142 so as to be adapted for extending toward a structure such as a building against which the ladder 50 and attachment assembly 101 may be supported. The method may further include forming the upper portions 142 so as to have distal ends 150 defined thereon, which are adapted to engage the structure when the standoff assembly 101 is properly positioned for use.

Still referring to FIGS. 1-8, the method may include forming one or more cross pieces 120, 130. The cross pieces 120, 130 may be formed from galvanized steel, aluminum alloy sheet, or other suitable materials. The cross pieces 120, 130 are preferably formed so as to be adapted for connection with and detachment from the ladder 50. The method further includes connecting at least one cross piece 120, 130 between the lower portions 141 of the arms so as to join the arms. In accordance with the method, a substantially dielectric upper strut 160 is connected between the upper portions 142 of the arms for stabilizing the upper portions relative to each other. The upper strut 160 is advantageously formed from a dielectric material such as plastic tubing or plastic bar. In accordance with the preferred embodiment of the inventions, the upper strut 160 is connected to the arms by drilling through the ends of the upper strut and also drilling through the arms at the connection point, after which dielectric fasteners are inserted through the drilled holes to connect the strut with the arms.

The method includes positioning a dielectric sheath 144 on each of the arms to cover at least a portion of each arm. Preferably, the dielectric sheath 144 is positioned by first placing an inner layer 146 over each arm 140. The inner layer 146 is preferably a length of substantially rigid tubing such as polyvinylchloride tubing. Next, an intermediate layer 147 is placed over the inner layer 146. The intermediate layer 147 is preferably a length of plastic corrugated tubing having at least some ability to flex. The inner layer 146 and intermediate layer 147 are preferably of substantially the same length. A nylon fastener is one suitable form of connection. Suitable materials may include those recited above for the outer layer.

Next, an outer layer 148 is placed over the intermediate layer 147. The outer layer 148 is preferably longer than both the inner layer and intermediate layer. In accordance with the exemplary embodiment, the outer layer 148 is a length of heat shrink tubing. The method preferably includes applying to the shrink tubing an amount of heat sufficient to shrink the outer layer, and more preferably tightly, over the intermediate layer 147 and/or the inner layer 146, such as by using a hot air gun or other ways of applying an adequate amount of temperature increase so the material shrinks. Most preferably, the shrink tubing is of a sufficient size and length, and the applied heat is of a sufficient quantity, to cause the shrink tubing to substantially seal the ends of the dielectric sheath 144 by causing the shrink tubing to extend beyond the ends of the inner layers to seal tightly around the arm 140.

### Manner of Use and Utility of the Inventions

One or more aspects of the inventions taught herein include using the apparatus 101 with a ladder 50 as shown in FIGS. 5 and 6. In preparation for use, the apparatus 101 may be mounted or attached to a ladder 50, and more preferably, to an upper portion or top of the ladder as shown. Mounting or attachment of the standoff apparatus 101 to the ladder 50 may be accomplished by placing the standoff in a proper orientation relative to the ladder, and then lowering the apparatus so that a rung 52 of the ladder 50 is received into a respective cross piece 120, 130. One or more latches 60 may then be positioned to engage the retainer features 132. In this manner, the apparatus 101 may be securely attached to the ladder.

After attaching the apparatus 101 to the ladder 50 as just described, the ladder, together with the mounted apparatus, can be moved into position adjacent to a structure such as a building (not shown). The ladder 50 with mounted apparatus 101 may then be leaned against the structure so as to place the end caps 151 against the structure, wherein the ladder and apparatus are leaning in a stable manner against the structure. The user may then climb the ladder 50 and/or the apparatus 101 to access a desired location on the structure.

Benefits associated with one or more aspects of the inventions taught herein include various dielectric components that serve to decrease likelihood of electrocution of the user of the apparatus 101. More specifically, the dielectric properties of the sheath 144 and/or the end caps 151 and/or the upper strut 160 and/or strut fasteners 162 can serve to insulate or otherwise protect a user of the apparatus 101 from dangerous electrical current, should the apparatus come into close proximity and/or contact with a source of a dangerous level of electric power.

### Preferred Manners of Making

Various portions and components of apparatus within the scope of the inventions, including for example, structural components, can be formed by one or more various suitable manufacturing processes known to those in the art of fabrication. Similarly, various portions and components of apparatus within the scope of the inventions can be made from suitable materials known to those in the art of fabrication and electrical power.

### Interpretation Notes

The above description has set out various features, functions, methods and other aspects of the inventions. This has been done with regard to the currently preferred embodiments thereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

I claim:

1. An apparatus forming a ladder standoff attachment for use with a ladder to stabilize the ladder against a structure and provide protection against electrical shock, comprising:
at least two arms shaped to provide lower portions and upper portions, said upper and lower portions being joined together, said lower portions being connectible to a ladder and the upper portions being adapted for extending toward a structure, the two upper sections having distal ends which are adapted to engage a structure when the ladder standoff is properly positioned for use with the structure;
dielectric end pieces mounted upon distal ends of said at least two arms for engaging the structure so as to prevent or impede electrical charge passing to, from or through said at least two arms;
at least one cross piece connected between the lower portions of the at least two arms to join the arms, said at least one cross piece being in the form of a rung which is received in complementary relationship with a ladder to which the apparatus may be mounted, said at least one cross piece being adapted for connection of the stand-off to a ladder and detachment from the ladder;
a dielectric sheath covering said at least two arms to substantially prevent electrical charge from flowing to or from the at least two arms from a source of electrical charge, said dielectric sheath having at least a first layer and a second layer to provide impedance against electrical flow therethrough;
said dielectric sheath having a plurality of dielectric layers surrounding the upper portion and at least parts of the lower portions of the at least two arms;
at least one substantially dielectric upper strut connected between the upper portions of the at least two arms, for stabilizing the upper portions relative to each other.

2. An apparatus according to claim 1 wherein the lower portions of the arms are in substantially parallel orientation.

3. An apparatus according to claim 1 wherein the upper portions of the arms are substantially divergent.

4. An apparatus according to claim 1 wherein the dielectric sheath comprises:
an inner layer of substantially rigid tubing;
an intermediate layer of corrugated tubing;
an outer layer of heat shrink tubing.

5. An apparatus forming a ladder standoff attachment for use with a ladder to stabilize the ladder against a structure and provide protection against electrical shock, comprising:
at least two arms shaped to provide lower portions and upper portions, said upper and lower portions being joined together, said lower portions being connectible to a ladder and the upper portions being adapted for extending toward a structure, the two upper sections having distal ends which are adapted to engage a structure when the ladder standoff is properly positioned for use with the structure;
dielectric materials upon the at least two arms for engaging the structure so as to prevent or impede electrical charge passing to, from or through said at least two arms;
at least one cross piece connected between the lower portions of the at least two arms to join the arms, said at least one cross piece being adapted for connection to a ladder and for detachment from the ladder;
a dielectric sheath covering said at least two arms to substantially prevent electrical charge from flowing to or from the at least two arms from a source of electrical charge;
said dielectric sheath having a plurality of dielectric layers surrounding the upper and lower portions of the at least two arms;
at least one substantially dielectric upper strut connected between the upper portions of the at least two arms, for stabilizing the upper portions relative to each other.

6. An apparatus according to claim 5 wherein the lower portions of the arms are in substantially parallel orientation.

7. An apparatus according to claim 5 wherein the upper portions of the arms are substantially divergent.

8. An apparatus according to claim 5 wherein the dielectric sheath comprises:
an inner layer of substantially rigid tubing;
an intermediate layer of corrugated tubing;
an outer layer of heat shrink tubing.

9. A method of fabricating a ladder standoff attachment for use with a ladder to stabilize the ladder against a structure and provide protection against electrical shock, comprising:
forming at least two arms shaped to provide lower portions and upper portions, said upper and lower portions being joined together, said lower portions being connectible to a ladder and the upper portions being adapted for extending toward a structure, the two upper sections having distal ends which are adapted to engage a structure when the ladder standoff is properly positioned for use with the structure;
positioning a dielectric sheath to cover at least a portion of each said at least two arms to substantially prevent electrical charge from flowing to or from the at least two arms from a source of electrical charge, said dielectric sheath having at least a first layer and a second layer to provide impedance against electrical flow therethrough;
connecting at least one cross piece between the lower portions of the at least two arms to join the arms, said at least one cross piece being adapted for connection to the ladder and for detachment from the ladder;
connecting at least one substantially dielectric upper strut between the upper portions of the at least two arms, for stabilizing the upper portions relative to each other.

10. An apparatus according to claim 9 wherein the lower portions of the arms are in substantially parallel orientation.

11. An apparatus according to claim 9 wherein the upper portions of the arms are substantially divergent.

12. An apparatus according to claim 9 wherein the dielectric sheath comprises:
an inner layer of substantially rigid tubing;
an intermediate layer of corrugated tubing;
an outer layer of heat shrink tubing.
